(19) United States
(12) Patent Application Publication
(10) Pub. No.: US 2002/0079627 A1
(43) Pub. Date: Jun. 27, 2002

(54) Shock isolator

(76) Inventors: Trevor J. McCollough, Minneapolis, MN (US); Wesley Eugene Revely, Apple Valley, MN (US); Brian Scott Leininger, Woodbury, MN (US); Robert James Monson, St. Paul, MN (US)

Correspondence Address: Carl L. Johnson, Jacobson and Johnson, Suite 285, One West Water Street, St. Paul, MN, 55107-2080, US

(21) Appl. No.: 09/745,368

(22) Filed: Dec. 22, 2000

(51) Int. Cl. B60G 11/22; F16F 1/44; F16F 1/18

(52) U.S. Cl. 267/107; 248/609; 267/153; 267/293; 267/165

(57) ABSTRACT

A molded or non-molded elastomeric shock cell having a base with legs extending from each side of the base with each of the legs having a foot that extends laterally outward from the legs to provide a unitary elastomeric shock cell that can be individually mounted to support plates or a plurality of elastomeric shock cells can be ganged, or stacked together to produce a composite isolator with different shock isolation characteristics. The elastomeric shock cell if mountable in one axis provide tension resistance and if mounted in a bias axis or right angle axis provide tension and compression resistance to shocks to the system.

### FIELD OF THE INVENTION

This invention relates to shock isolators and more specifically to shock isolators comprised of one or more molded or non-molded elastomeric shock cells.

### BACKGROUND OF THE INVENTION

Various elastomeric materials have been used, or suggested for use, to provide shock and/or vibration damping as stated in U.S. Pat. No. 5,766,720, which issued on Jun. 16, 1998 to Yamagisht, et al. These materials include natural rubbers and synthetic resins such as polyvinyl chlorides, polyurethane, polyamides polystyrenes, copolymerized polyvinyl chlorides, and poloyolefine synthetic rubbers as well as synthetic materials such as urethane, EPDM, styrene-butadiene rubbers, nitrites, isoprene, chloroprenes, propylene, and silicones. The particular type of elastomeric material is not critical but urethane material sold under the trademark Sorbothane® is currently employed. Suitable material is also sold by Aero E.A.R. Specialty Composites, as Isoloss VL. The registrant of the mark Sorbothane® for urethane material is the Hamiltion Kent Manufacturing Company (Registration No. 1,208,333), Kent, Ohio 44240.

The elastomeric elements employed in the prior art were commonly formed into typical geometric 3D shapes, such as spheres, squares, right circular cylinders, cones, rectangles and the like as illustrated in U.S. Pat. No. 5,776,720. These typical geometric shapes, do not minimize or eliminate shock and vibration to the degree accomplished by the elastomeric shock cells of the present invention.

### DESCRIPTION OF THE PRIOR ART

U.S. Pat. No. 4,059,254 shows an energy absorbing unit comprising an elastomeric member arranged in a trapezoidal configuration. A sliding piston is incorporated in the unit which has limited displacement due to a pin that slides within an elongated slot.

### SUMMARY OF THE INVENTION

Briefly, the invention comprises a molded or non-molded elastomeric shock cell having a base with legs extend from each side of the base with each of the legs having a foot that extends outward from the legs to provide a elastomeric shock cell that can be individually mounted to support plates or a plurality of elastomeric shock cells can be ganged, or stacked together to change the shock isolation characteristics. The elastomeric shock cell if mountable in one axis provides tension resistance and if mounted in another axis provides tension and compression resistance to shocks and vibrations to the system.

### BRIEF DESCRIPTION OF THE DRAWINGS

FIG. 1 is a perspective view of a molded elastomeric shock cell for incorporating in a shock mount;

FIG. 1a is a side view of the molded elastomeric shock cell of FIG. 1 with dashed lines indicating the angle cutting of the molded elastomeric shock cell to produce an angular shock cell;

FIG. 1b is a perspective view of a sheet of elastomeric material that can be mechanically deformed into the elastomeric shock cell of FIG. 1;

FIG. 2 is an end view of an elastomeric shock cell supported by rigid mounting plates to provide a shock mount with shear and tension support;

FIG. 3 is a side view of the elastometic shock cell of FIG. 2;

FIG. 4 is an end view of the elastomeric shock cell of FIG. 2 wherein the elastomeric shock cell has been compressed to illustrate that the elastomeric shock cell can provide a cushion effect when compressed;

FIG. 5 is a front view of a cabinet with a set of shock isolators holding the inner compartment in a shock isolated condition;

FIG. 6 is a perspective view of a shock mount housing for containing a elastomeric shock cell;

FIG. 7 is a side view of the shock mount housing of FIG. 6;

FIG. 8 is a perspective view of a set of molded elastomeric shock cells that are connected together in an and to end relationship;

FIG. 8a is an end view of the set of molded elastomeric shock cells of FIG. 8 indicating the bias cut to produce parallel but angled mounting faces;

FIG. 9 is a front view of a set of molded elastomeric shock cells that are connected together in an end to end relationship as shown in FIG. 8 and are further stacked on each other to produce an elastomeric array;

FIG. 9A is an end view of the set of molded elastomeric shock cells of FIG. 9 indicating the bias cut to produce parallel but angled mounting faces;

FIG. 10 is a partial perspective view of molded elastomeric shock cells secured to each other to from an elongated shock cell chain with damping material located in a recess in the elongated shock cell chain;

FIG. 11 is a perspective of molded elastomeric shock cells secured to each other to from a set of three elongated shock cell chains with the elongated shock cell chains bonded to each other;

FIG. 12 is an end view of the elongated shock cell chains of FIG. 11;

FIG. 13 is a perspective view of an elastomeric sheet of material with angled relief areas removed from the elastomeric sheet of material;

FIG. 14 is a top view of the elastomeric sheet of material of FIG. 14 in a folded condition to produce an angular shock mount;

FIG. 15 is a side view of the folded elastomeric sheet material of FIG. 14;

FIG. 16 is a perspective view of an alternate embodiment wherein the elastomeric shock cells are circumferentially connected to form an annular shock isolator;

FIG. 17 is a front view of the annular shock isolator of FIG. 16; and

FIG. 18 is a top view of an alternate embodiment of a shock isolator wherein the elastomeric shock cells are formed by adhering strips of elastomeric sheet material to each other to form a series of end-to-end elastomeric shock cells that are stacked on each other.

### DESCRIPTION OF THE PREFERRED EMBODIMENT

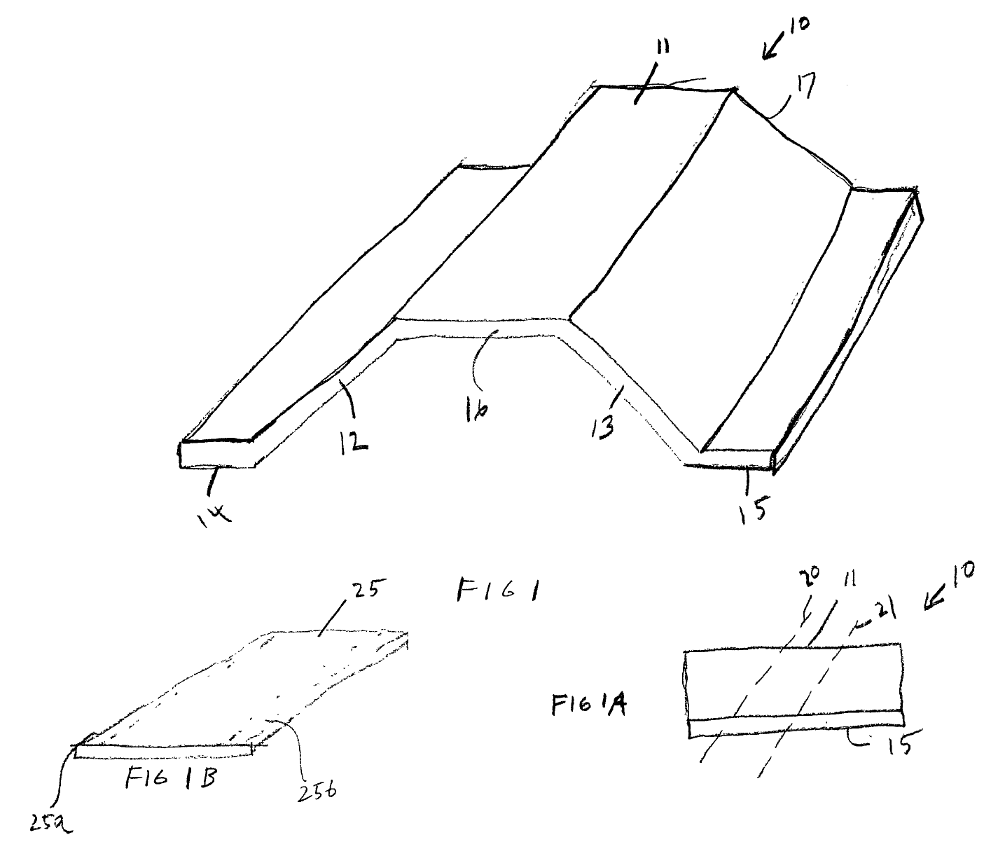

FIG. 1 is a perspective view of a molded elastomeric shock cell 10 for incorporating in a shock mount or shock isolator. Cell 10 comprises an elastomeric member that includes a base 11 having a first integral leg 12 extending angularly at a first angle from one edge of base 11 and a second integral leg 13 extending angularly from the opposite edge of base 11. A first integral foot 14 extends laterally outward from the lower end of leg 12 and similarly a second integral foot 15 extends laterally outward from the lower end of leg 15 to form an open cell. In the embodiment shown the base 11 and feet 14 and 15 are located in a parallel spaced apart condition to permit mounting of support plates thereon to thereby enable the shock cell 10 to be incorporated into a shock mount to enable the elastomeric member to isolate shock from one support plate to the opposite support plate.

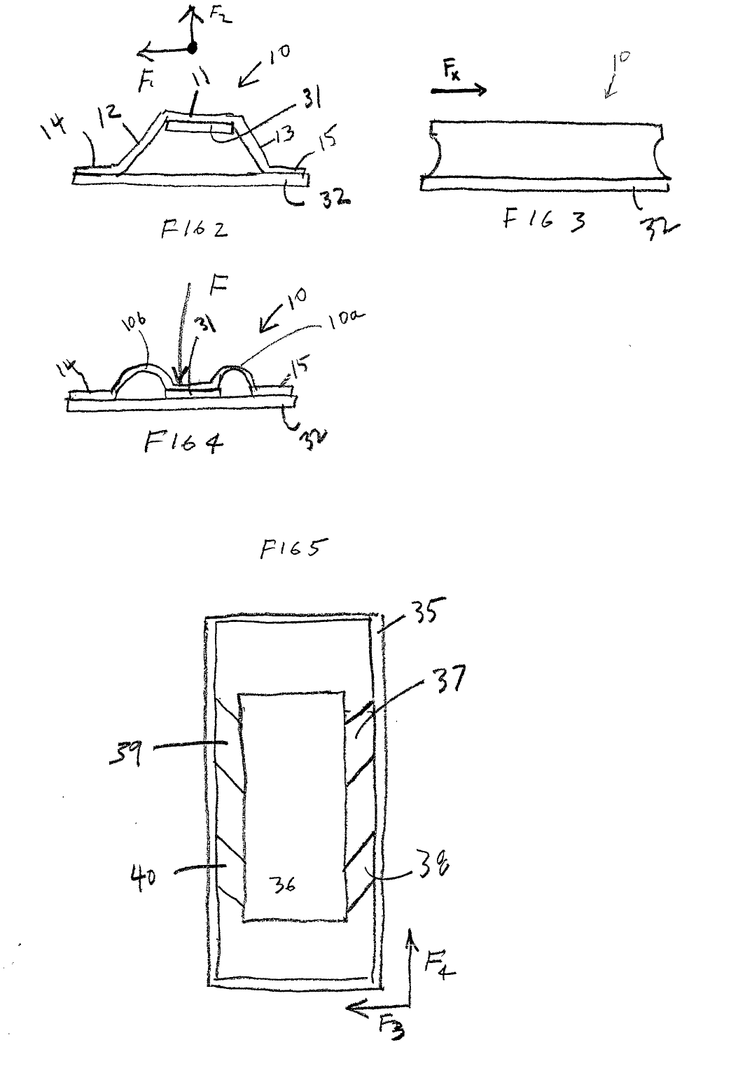

In the embodiment shown in FIG. 1 a first support plate can be secured to base 11 and a second support plate can be secured to feet 14 and 15 to provide parallel support plates for positioning the shock cell in a shock isolation condition. Positioning of support plates on base 11 and feet 14 and 15 provides an elastomeric shock cell with tension resistance. FIG. 1 shows elastonieric shock cell 10 has a generally inverted U-shape and FIGS. 2-4 illustrated the elastomeric shock cell 10 in a tension mode which provides tension or elongation resistance to shock and vibration.

While FIGS. 1-4 show a tension mode a feature of the present invention is that in addition to a tension mode the elastomeric cell 10 can also be mounted in a tension and compression mode to provide both compression resistance and elongation resistance to shock and vibration forces.

FIG. 1 shows elongated elastomeric shock cell 10 has a front end face 16 and a rear end face 17 located on the rear thereof with front end face 16 and rear end face 17 located in a parallel condition to permit attachment of support plates thereto rather than to feet 14, 15 and base 11. By mounting support plates to front end face 16 and rear end face 17 instead of feet 14, 15 and base 11 the elastomeric shock cell 10 can be positioned to provide both elongation and compression resistance to shock and vibration.

A further feature of the elastomeric cell is the ability to change characteristics of the elastomer cell 10 without changing the composition of the elastomeric cell by utilizing a bias cut to form angled end faces rather than an orthogonal cut which produces right angle end faces. FIG. 1A illustrates the bias cut to produce angled end faces. FIG. 1A is a side view of the molded elastomeric shock cell 10 with dashed lines 20 and 21 representing planes that extend at an angle through elastomeric shock cell 10. If the elastomeric shock cell 10 is cut along planes indicated by the dashed lines 20 and 21 it produces a bias cut with each of the cut faces at an angle other than a right angle to base 11 and foot 15. One can secure a rigid support plate to each of the cut faces to produce a shock mount with a bias cut. By cutting the elastomeric shock cell 10 on a bias angle i.e. (an angle that is not normal to a major face) the damping and shock isolation characteristics of the elastomeric shock cell 10 can be changed. Thus the designer not only has the option of changing materials to change the operational characteristics of the elastomeric shock cell 10 but the dynamic characteristics of the elastomeric shock cell 10 can also be changed by the faces selected for securing the elastomeric shock cell 10 to the rigid support plates. This feature is particularly useful where the type of elastomer materials may be limited by environmental factors but shock mounts of different operating ranges are required.

FIG. 2 shows a molded elastomer material 10 having a base 11 with a first leg 13 extending from a first side of the base 11 and a second leg 12 extending from the second side of the base 11, with each of the legs positioned at an angle of less than 180 degrees with respect to the base but more than 90 degrees with respect to base with the base securable to a first support surface or rigid plate 31 and feet 14 and 15 extending from the legs securable to a second support surface 32 so that a shock received by either the first support 31 is isolated from the second support 32 or a shock received by the second support 32 is isolated from first support 31 by the tension resistance of the elastomer material 10.

While FIG. 1 and FIG. 1A show a molded elastomeric shock cell, that is a cell in which the shape of the cell in the relaxed state appears as shown in FIG. 1. FIG. 1B is a perspective view of a non-molded or flat sheet of elastomeric material that can be mechanically deformed forming an elastomeric shock cell. To illustrate elastomeric shock cell 10 in a molded or unmolded condition reference should be made to FIGS. 1 to 4.

FIG. 2 is an end view of an elastomeric shock cell 10 supported by a top rigid mounting plate 31 that is secured to base 11 and a lower rigid mounting plate 32 that is secured to foot 14 and to foot 15 to provide a shock mount with tension support. In the embodiment shown in FIG. 2 the elastomeric shock cell 10 can be either molded or non-molded. If the elastomeric shock cell 10 is molded the plates 31 and 32 can be directly secured to the respective base and feet of the elastomeric shock cell 10. On the other hand if a sheet of elastomeric material 25, as shown in FIG. 1B, is used the edges of the elastomeric sheet can be secured at areas 25a and 25b to a first rigid base plate to form the elastomeric sheet into a bowed shape indicated in FIG. 2. The second base plate 31 can then be secured to the middle portion of the bowed shape which results in an elastomeric shock cell having substantially the same appearance as the formed elastomeric shock cell shown in FIG. 2.

FIG. 3 is a side view of the elastomeric shock cell 10 of FIG. 2 and FIG. 4 is an end view of the elastomeric shock cell of FIG. 2 wherein the elastomeric shock cell 10 has been compressed. A feature of the tension mode mount shown in FIG. 2 is that while the elastomer material lacks sufficient rigidity to withstand buckling forces it does provide a cushion effect in the event of a major collapsing force. That is, the elastomer legs 12 and 13 buckle in response to force F. With the base and foot mounting of rigid plates in the tension mode as shown in FIG. 2 it is not intended to provide compression resistance, however, the shock cell 10 shown in FIG. 4 does provides a bottom cushioning effect. That is, if the base plate 31 is forced toward base plate 32 the article attached to base plate 31 would engage the resilient protrusions 10a and 10b before the base plate 10 reached the contact postion thereby providing a cushioning effect.

FIG. 2 shows force arrows F₁ and F₂ positioned above base 11 of elastomer shock cell 10. In contrast to the compressive force F illustrated in FIG. 4 the direction of forces F₁ and F₂ cause the elastomer member to be maintained in tension as the forces F₁ and F₂ are balanced by the internal tension forces within the elastomer member.

FIG. 3 shows force arrows F₅ and F₆ positioned above base 11 of elastomer shock cell 10. Forces F₅ and F₆ cause the elastomer member to maintained in tension as the forces F₅ and F₆ are balanced by the internal tension forces within the elastomer member.

FIG. 5 is a front view of a housing 35 with a set of shock mounts or shock isolators 37, 38, 39 and 40 supporting an inner cabinet 36 in a shock isolated condition. Shock isolators 37 and 39 are located in a paired condition as are shock isolators 38 and 40. That is, one end of shock isolator 37 is secured to housing 35 and the other end is secured to one side of cabinet 36 while shock isolator 39 has one end secured to housing 35 and the other end secured to the other side of cabinet 36 so that both shock isolators 37 and 39 coact to hold the cabinet in a central position in housing 35. Similarly, shock isolators 38 and 40 are located in a paired condition with one end of shock isolator 38 secured to housing 35 and the other end secured to one side of cabinet 36 while shock isolator 40 has one end secured to housing 35 and the other end secured to the other side of cabinet 36 so that both shock isolators 38 and 40 also coact to hold the cabinet in a central postion in housing 35. In the embodiment shown the shock isolators are all mounted in the tension mode. That is the shock cells as shown in FIG. 2 are mounted such that support plate 11 would be mounted to cabinet 11 and support plated 32 would be mounted to housing 35 or vice versa.

To illustrate shock forces to a paired support, force arrows F₃ and F₄ are positioned proximate the outer housing. In operation of the system the shock forces impacting on housing 35 would be isolated from cabinet 36 by the coaction of the opposite pairs of shock isolators 37 and 39 as well as the opposite pairs of shock isolators 38 and 40 if the shock isolators are mounted in the tension mode. That is, although neither of shock isolators 37 or 39 provide compression resistance (see FIG. 4) one of the shock isolators 37 or 39 will always be in a tension resistance mode in response to force F₃ whether the force F₃ is positive or negative. Consequently, with a paired arrangement as shown in FIG. 5 a pair of shock isolation cells each providing elongation resistance can be mounted in a paired postion to provide for shock isolation by the coaction of the two oppositely disposed shock isolators.

FIG. 3 illustrates a side view of the shock isolator of FIG. 2 with Fₓ indicating the direction of an axial shock force that can be absorbed by the shock isolator 10.

In some instances it may be desirable to have shock isolators that provide both compression resistance and elongation resistance. For these conditions the elastomeric shock cell is supported on end faces 16 and 17 rather than lateral faces provided by base 11 and feet 14 and 15. The end face mount and bias mount allows the user the option of providing both tension and compression resistance and is suitable in those situations where only one shock isolator can be used. To illustrate the alternate embodiment having a compression and tension mode reference should be made to FIGS. 8 to 14.

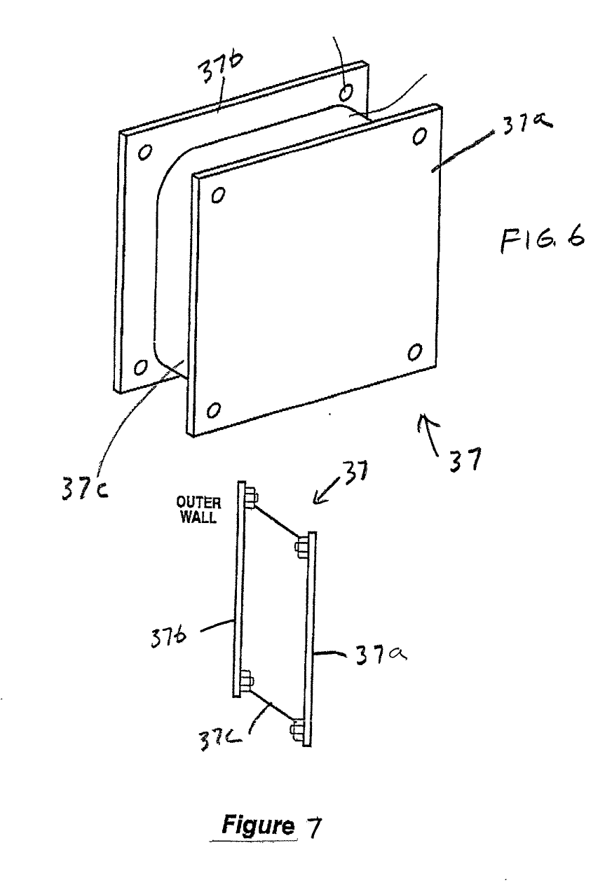

FIG. 6 is a perspective view of shock isolator or shock mount housing 37 that provides partial support for cabinet 36 in housing 35. Shock mount housing 37 contains a elastomeric shock cell 10 mounted in the tension mode as illustrated in FIG. 2. FIG. 7 is a side view of the shock mount housing 37. The shock mount housing 37 includes a first rigid base plate 37a and a second rigid base plate 37b which are located in a spaced parallel postion with a protective covering 37c extending around the elastomeric shock cell located in the shock mount housing 37. While FIG. 6 shows a protective covering 37c over the elastomeric shock cell it will be understood that such feature is optional and depends on the conditions of use of the shock mount housing. As the shock isolators 38, 39 and 40 are identical they will not be described herein.

Thus, with the tension mode embodiment shown in FIGS. 2 one can isolate a cabinet of the like from external shock and vibration using paired mounting of isolators as shown in FIG. 5.

A further feature of the present invention is that the elastomeric cell 10 can be stacked or connected in an end-to-end condition to produce different structural configurations thereby increasing the useful operating ranges of the shock isolator. FIG. 8 is a perspective view of two molded elastomeric shock cells that are connected together in an end to end relationship to form an elastomeric shock cell chain 50. In the embodiment shown the molded elastomeric shock cell chain 50 forms an undulating surface. The elastomeric shock cell chain 50 can be mounted in a variety of axis with the rigid support plates mounted to various parallel surfaces.

FIG. 8a is an end view of the set of molded elastomeric shock cell chain 50 with the letter V indicates a vertical to illustrate a bias cut to produce parallel but angled mounting faces 50a and 50b.

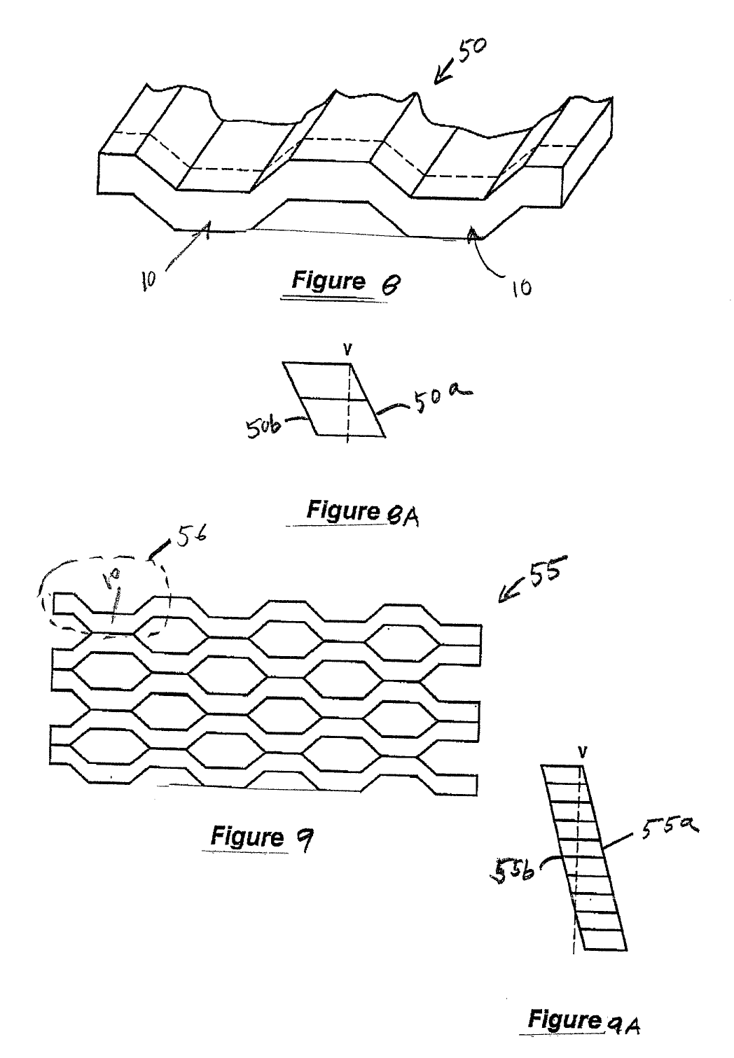

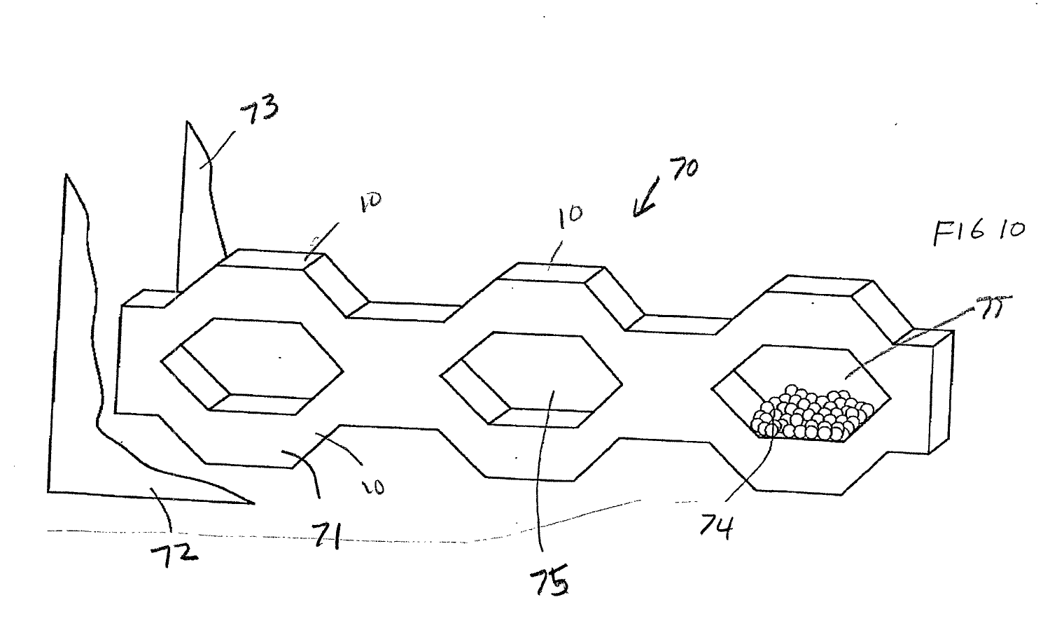

Referring to FIG. 9 there is shown a front view of a set of molded elastomeric shock cells 10 that are connected together in an end to end relationship and are further stacked on each other to produce an elastomeric shock cell array 55 comprised of multiple elastomeric shock cells 10. A dotted line 56 extends around an individual elastomer shock cell 10 to illustrate the elastomeric shock cell in shock cell array 55.

FIG. 9A is an end view of the set of molded elastomeric shock cells in an array 55 with a vertical line indicated by V to illustrate the bias cut to produce parallel but angled mounting faces 55a and 55b. It will be noted that in the embodiment shown in FIG. 8 and 9 that the positioning of the support plates on the end surfaces 50a and 50b or 55a and 55b produces a compression resistance to the shock array. That is, the individual cells do not buckle in response to forces since the array maintains each of the cells in a compression resistance condition. It should be pointed out that the ability to have an elastomeric shock cell that can be mounted in any of a number of different support positions enables one to closely match the shock isolation system to the type and duration of shock and vibration that occurs under field conditions as well as the type and mass of loads to be protected.

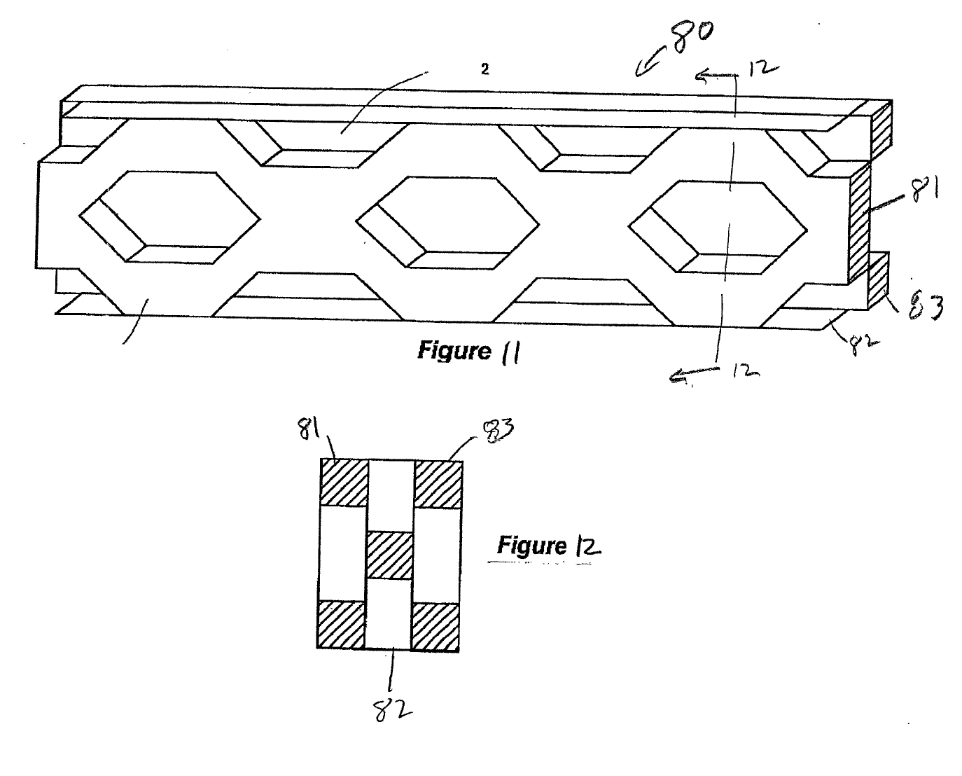

FIG. 10 is a partial perspective view of molded elastomeric shock cells 10 secured to each other to from an elongated elastomeric shock cell chain 70. A rigid back plate 73 (shown partially) extends along and is secured to the back side of elongated elastomeric shock cell chain 70 by suitable adhesive or the like and similarly a rigid front plate 72 (only partially shown) extends along and is secured to front face 71 of elongated elastomeric shock cell chain 70 by a suitable adhesive or the like. The elongated elastomeric shock cell chain 70, which is formed of open elastomeric shock cells 10, contains internal regions or cavities 75 which can be partially filled with a damping material such as tungsten carbide pellets to enhance the damping of the system. With the embodiments shown in FIG. 10 one can obtain the benefits of the shock isolation and can enhance damping by partially filing the recess 75 with damping material . The elongated elastomeric shock cell chain 70 is shown with rigid plates 73 and 72 mounted on the right angle end faces of the elongated elastomeric shock cell chain 70 to thereby provide compressive resistance as well as tension resistance to external forces. Thus, the embodiment of FIG. 10 as well as the embodiment shown in FIG. 9, provide for shock and vibration resistance in both the compressive and tension mode.

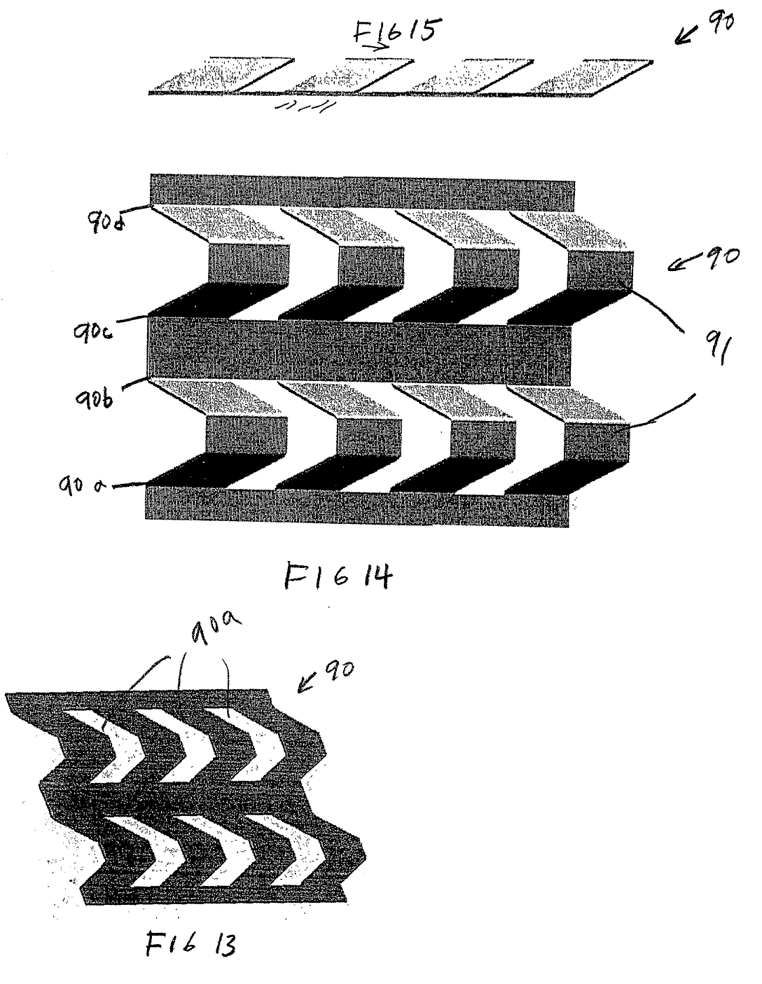

FIG. 11 is a perspective of molded elastomeric shock cells 10 secured to each other in a back to back arrangement to form an elongated shock cell chain array 80 with the elongated shock cell chains in the array bonded to each other by a suitable adhesive or the like so that the elongated shock cell chain array 80 acts as a unit. In the embodiment shown elongated shock cell chain array 80 includes a first elastomeric shock cell chain 81, a second elongated elastomeric shock cell chain 82 and a third elongated elastomeric shock cell chain 83 with the shock cell chains bonded together to form a single unit. FIG. 12 is an end view of the elongated shock cell chains 80 illustrating that the elongated elastomeric shock cell chains are arranged in a staggered condition so that the open region of one shock cell is positioned proximate a closed region of an adjacent shock cell.

FIG. 13 is a perspective view of an alternate method of making a ganged set of elastomeric shock cells 10 from a single sheet of elastomeric sheet of material 90. The sheet of material 90 which is shown in a flat or planer condition in FIG. 13 has been cut to provide U-shaped relief areas 90a in the sheet 90.

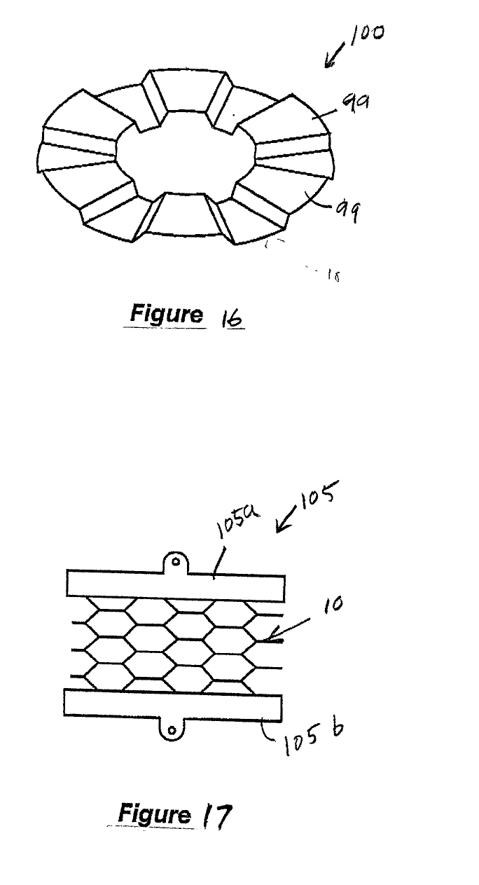

FIG. 14 is a top view of the elastomeric sheet of material 90 in a folded condition to produce an angular shock mount. That is, the sheet 90 has been folded along the lines indicated by 90a, 90b, 90c and 90d so that portions 91 extend upward in a U-shape. As the members are cut at an angle, as illustrated in FIG. 13, the result is that the individual shock cells extend angularly upward as shown in the side view shown in FIG. 15

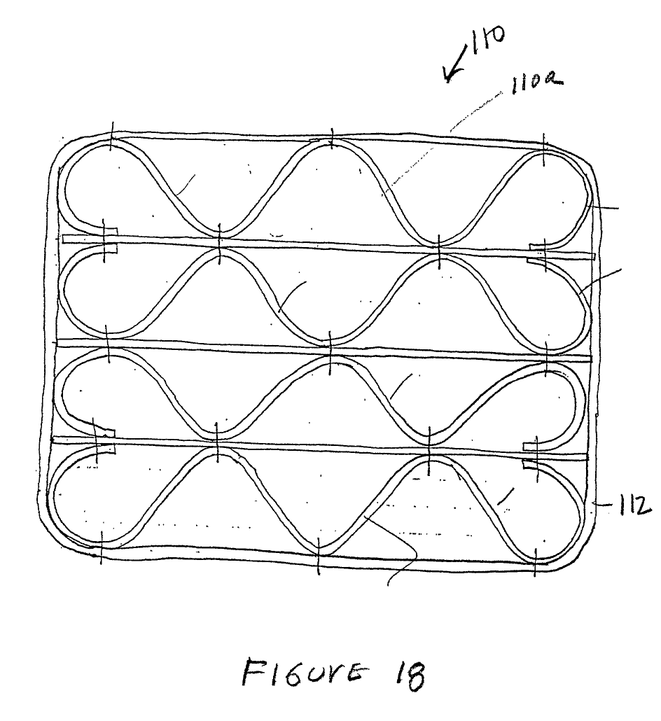

While the prior embodiments have illustrated the linear arrangement of elastomeric shock cells the elastomeric shock cells can also be arranged in an annular condition. FIG. 16 is a perspective view of an alternate embodiment wherein the elastomeric shock cells 99 are circumferentially connected to form an annular shock isolator 100 comprised of individual shock cells 99. The circumferential elastomeric shock cells 99 can further be stacked as illustrated in the front view shown in FIG. 17 which forms annular shock isolator 105 having a rigid top plate 105a and a rigid bottom plate 105b. This embodiment is suitable for shock isolation that require a single axis mounting or resistance to torsional forces.

FIG. 18 is a top view of an alternate embodiment of a shock isolator 110 wherein the elastomeric shock cells 110a are formed by bending and adhering strips of elastomeric sheet material to each other to form a series of end-to-end elastomeric shock cells that are stacked on each other. The entire stacked and ganged elastomeric shock cells produce an array which is secured by a protective covering 112. In the embodiment shown the support plates can be mounted to end faces of the shock cells 110a with the array arrangement providing integrity to the unit so that the shock isolator 10 containing the elastomeric shock cells 110a can provide both compression and tension resistance.

Thus it will be apparent that the present invention of shock cells provide for use over a wide range of conditions and that a shock isolator can be made by using only a single elastomeric material which is mated to the damping and shock isolation requirements by using additional elastomeric shock cells or by mounting the support plates on either a bias axis or on alternate axis.

We claim:

1. A shock isolator comprising:
a first mounting surface;
a second mounting surface;
a molded one-piece elastomer material forming an elastomeric shock cell, said molded elastomer material having a base secured to said first mounting surface, said base having a first leg extending laterally outward from a first side of said base and a second leg extending laterally outward from the second side of said base, each of said legs positioned at an angle of less than 180 degrees with respect to said base but more than 90 degrees with respect to said base, said one-piece elastomer material having a first foot secured integral to said first leg with said first foot extending laterally outward from said first leg in a first direction and a second foot integral to said second leg with said second foot extending laterally outward from said second leg in a direction opposite from said first direction, said first foot and said second foot securable to the second mounting surface so that a shock received by said first mounting surface is isolated from said second mounting surface and a shock received by said second mounting surface is isolated from said first mounting surface by a tension resistance of said one-piece elastomer material.

2. The shock isolator of claim 1 wherein the first and second mounting surfaces comprise parallel, spaced-apart, rigid plates that are bonded to a set of lateral faces of said one-piece elastomer material.

3. The shock isolator of claim 1 wherein the first and second mounting surfaces comprise parallel, spaced-apart rigid plates that are bonded to a set of end faces of said one-piece elastomer material.

4. The shock isolator of claim 3 wherein the parallel spaced apart rigid plates are bonded to a set of end faces cut on a bias angle.

5. The shock isolator of claim 1 wherein said one-piece molded elastomer material forms an open elastomeric shock cell.

6. The shock isolator of claim 1 wherein said one-piece molded elastomer material includes a plurality of elastomeric shock cells connected in an end to end relationship to form an elastomeric shock cell chain.

7. The shock isolator of claim 6 wherein said one-piece molded elastomer material includes a plurality of elastomeric shock cell chains connected in a side-to-side relationship to form an elastomeric shock cell array.

8. The shock isolator of claim 2 wherein the plurality of elastomeric shock cells are circumferentially positioned.

9. The shock isolator of claim 2 wherein the mounting surfaces are positioned on a surface located at a right angle to the elastomeric shock cell.

10. A shock isolator comprising:
a first support plate;
a second support plate
a sheet of elastomer material, said sheet elastomer material having a base with a first leg extending from a first side of said base and a second leg extending from the second side of said base, said base secured to said first plate, each of said legs having a laterally outward extending foot with each of said feet extending in opposite directions with each of said feet secured to said second support plated to hold said elastomer in a U-shape so that a shock received by said first support is tensional isolated from said second support and a shock received by said second support is tensional isolated from said first support.

11. The shock isolator of claim 10 wherein said sheet of elastomer material comprises an uncut sheet of elastomer material

12. The shock isolator of claim 10 wherein the sheet of elastomer includes cut-away reliefs so that when said sheet of elastomer material is mounted on said first plate and said second support plate the sheet can be folded to provide a plurality of elastomeric shock cells.

13. The shock isolator of claim 10 including strips of elastomeric material that are formed in a U-shape and secured to each other to form elastomeric shock cells.

14. The shock isolator of claim 13 including a protective covering surrounding said shock isolator.

15. The shock isolator or claim 14 wherein the first support plate is mounted on a first right angle end surface and the second support plated is mounted on a second rigid angle end surface to thereby provide compression resistance to said shock isolator

16. A shock isolation system comprising:
a housing;
a cabinet for mounting within said housing;
a first elastomer shock cell having a first end secured to said housing and a second end secured to said cabinet; and
a second elastomeric shock cell having a first end secured to said housing and a second end secured to said cabinet with said second elastomer shock cell positionally paired with said first elastomer shock cell on an opposite side of said cabinet so that a shock to the housing results in either one or both of the elastomeric shock cells providing tensional resistance to maintain the cabinet in a shock isolated condition.

17. The shock isolation system of claim 16 including:
a third elastomer shock cell having a first end secured to said housing and a second end secured to said cabinet; and
a fourth elastomeric shock cell having a first end secured to said housing and a second end secured to said cabinet with the third elastomer shock cell positionally paired with the fourth elastomeric shock cell on an opposite side of said cabinet so that a shock to the housing results in either one or both of the elastomeric shock cells providing tensional resistance to maintain the cabinet in a shock isolated condition.

18. The shock isolation system of claim 16 including a plurality of elastomeric shock cells forming an elastomeric shock cell chain.

19. The shock isolation system of claim 16 including a plurality of elastomeric shock cells forming an elastomeric shock cell array.

20. A method of isolating a shock or a vibration comprising:
forming an open elastomer cell having a base with laterally outward extending legs and laterally outward extending feet;
securing the base of the open elastomeric cell to a first member; and
securing the laterally outward extending feet to a second member to provide for support of the elastomeric cell between the first member and the second member.

21. The method of claim 20 wherein the first member is secured to a lateral face of the open elastomeric cell and the second member is secured to the feet of said open elastomer cell to provide an isolator for isolating forces in a tension mode.

22. The method of claim 20 wherein the first member is secured to a first end face of the open elastomeric cell and the second member is secured to a second end face of said open elastomer cell to provide an isolator for isolating forces in both a tension mode and a compression mode.

23. The method of claim 20 wherein a plurality of open elastomeric shock cells are connected together to form an open elastomer chain.

24. The method of claim 20 wherein a plurality of open elastomeric shock cell chains are connected together to form an elastomer shock cell array.

25. The method of claim 20 wherein the plurality of open elastomer shock cells are mounted in opposite sides of a cabinet so that each responds to tension forces but neither responds to compressive forces.

26. The method of claim 20 wherein a plurality of open elastomer shock cells are formed from a flat sheet of elastomeric material.

27. The method of claim 20 wherein the elastomer shock cell is made of a sheet of elastomeric material of uniform thickness.

28. The method of claim 20 wherein a plurality or elastomeric shock cells are cut in relief from a flat sheet of elastomeric material and the flat sheet of elastomeric material is folded to form a plurality of three dimensional elastomer shock cells.

29. The method of claim 20 including the step of placing a damping material in a cavity or the elastomeric shock cell.

30. The method of claim 29 wherein the step of placing a damping material comprises placing particles of tungsten carbide in the cavity of the elastomeric shock cells.
